(19) United States
(12) Patent Application Publication
(10) Pub. No.: US 2011/0103074 A1
(43) Pub. Date: May 5, 2011

(54) DIFFUSION SYSTEM FOR AND AUTOMATED LUMINAIRE

(75) Inventor: Pavel JURIK, Postredni Becva (CZ)

(73) Assignee: ROBE LIGHTING S.R.O.

(21) Appl. No.: 12/880,077

(22) Filed: Sep. 11, 2010

Related U.S. Application Data
(60) Provisional application No. 61/241,863, filed on Sep. 11, 2009.

(51) Int. Cl. F21V 11/00

(52) U.S. Cl. 362/355

(57) ABSTRACT

Described are an improved automated luminaire 12 and luminaire systems 10 employing an improved image diffusion system 27. The image diffusion system 27 is improved by providing a plurality of sets of optical diffusion elements that may be operated either concurrently or consecutively so as to provide an improved range and control of the applied image diffusion

### TECHNICAL FIELD OF THE INVENTION

The present invention generally relates to an automated luminaire, specifically to an optical system for use within an automated luminaire.

### BACKGROUND OF THE INVENTION

Luminaires with automated and remotely controllable functionality are well known in the entertainment and architectural lighting markets. Such products are commonly used in theatres, television studios, concerts, theme parks, night clubs and other venues. A typical product will commonly provide control over the pan and tilt functions of the luminaire allowing the operator to control the direction the luminaire is pointing and thus the position of the light beam on the stage or in the studio. Typically this position control is done via control of the luminaire's position in two orthogonal rotational axes usually referred to as pan and tilt. Many products provide control over other parameters such as the intensity, color, focus, beam size, beam shape and beam pattern. The beam pattern is often provided by a stencil or slide called a gobo which may be a steel, aluminum or etched glass pattern. The products manufactured by Robe Show Lighting such as the ColorSpot 700E are typical of the art.

The optical systems of such automated luminaires may include a variable diffusion or frost system. Such systems allow the user to soften or diffuse the image for artistic effect. These systems typically comprise pieces of frosted or diffusing optical material which may be moved across the light beam using a motor system. As the diffusing material is moved across the beam it will progressively diffuse or soften the image. Control of the position of the diffusing material allows the user to achieve the desired amount of diffusion or softening. Such a system may be limited in both its range and finesse of control as a single strength of diffusing optical material is used.

FIG. 1 illustrates a multiparameter automated luminaire system 10. These systems commonly include a plurality of multiparameter automated luminaires 12 which typically each contain on-board a light source (not shown), light modulation devices, electric motors coupled to mechanical drives systems and control electronics (not shown). In addition to being connected to mains power either directly or through a power distribution system (not shown), each luminaire is connected in series or in parallel to data link 14 to one or more control desks 15. The luminaire system 10 is typically controlled by an operator through the control desk 15.

FIG. 2 illustrates a prior art automated luminaire 12. A lamp 21 contains a light source 22 which emits light. The light is reflected and controlled by reflector 20 through optical devices 26 which may include dichroic color filters, effects glass and other optical devices well known in the art and then through an aperture or imaging gate 24. Optical components 27 may include variable diffusion, gobos, rotating gobos, iris and framing shutters. The final output beam may be transmitted through output lens system 31. Lens system 31 may be a glass lens or lens system providing beam angle control or zoom as well as focus adjustment.

There is a need for an improved variable image diffusion system for an automated luminaire which provides improved range and finer control of the applied diffusion.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates a typical automated lighting system;

FIG. 2 illustrates a prior art automated luminaire and;

FIG. 3 illustrates an improved diffusion system for an automated luminaire.

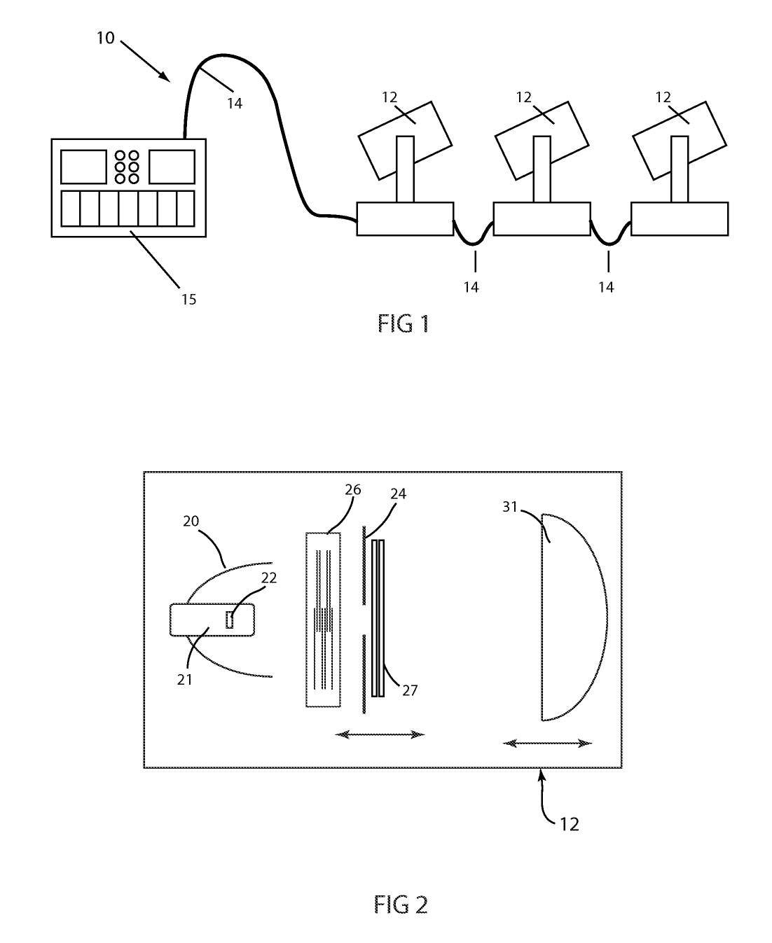

### DETAILED DESCRIPTION OF THE INVENTION

Preferred embodiments of the present invention are illustrated in the FIGUREs, like numerals being used to refer to like and corresponding parts of the various drawings.

The present invention generally relates to an automated luminaire, specifically to the configuration of a variable image diffusion system within such a luminaire such that said image diffusion system provides a wide range and fine control of the applied image diffusion.

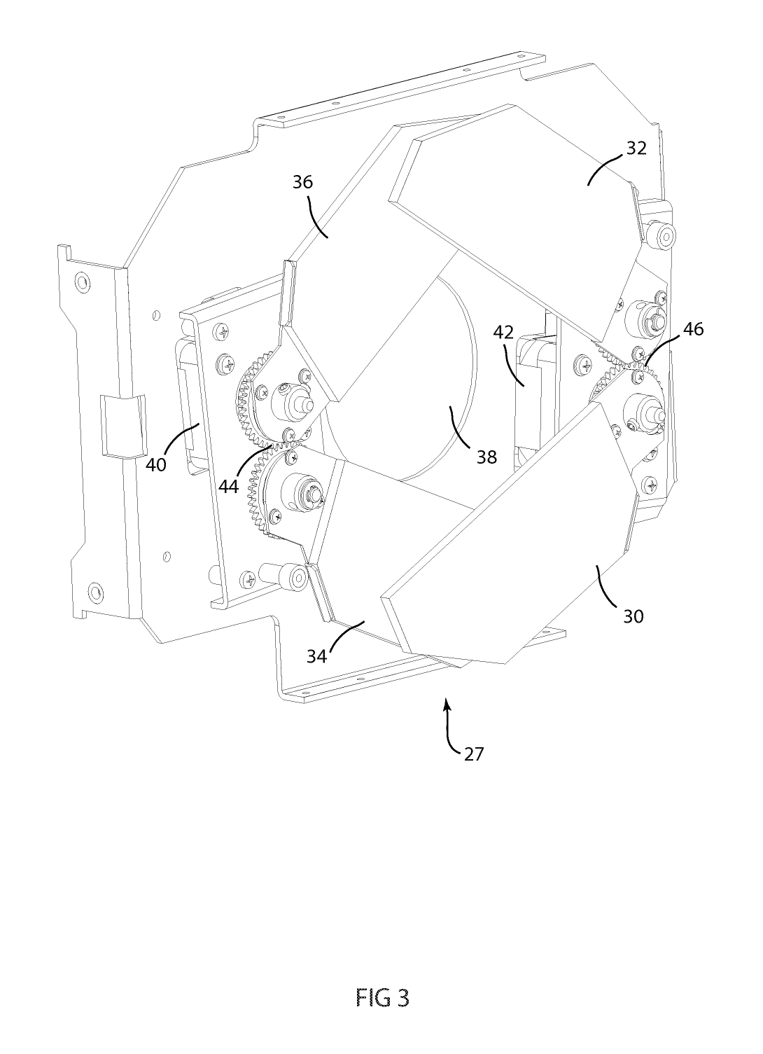

FIG. 3 illustrates an embodiment of the invention. Variable diffusion system 27 comprises two pairs of optical diffusion flags 30 & 32 and 34 and 36. First pair of optical diffusion flags 30 and 32 may be opened and closed over aperture 38 through gears 46 and motor 42. As motor 42 rotates, gears 46 are caused to rotate in contrary directions thus moving attached diffusion flags 30 and 32 in contrary directions. Second pair of optical diffusion flags 34 and 36 may be opened and closed over aperture 38 through gears 44 and motor 40. As motor 40 rotates, gears 44 are caused to rotate in contrary directions thus moving attached diffusion flags 34 and 36 in contrary directions.

First pair of optical diffusion flags 30 and 32 may have the same diffusion density or may differ in their diffusion density from second pair of optical diffusion flags 34 and 36. Light passing through aperture 38 will pass through the first pair of diffusion flags 30 and 32 and second pair of diffusion flags 34 and 36 and the resultant image will be affected by the combination of the first and second diffusion flags and the degree to which each flag is engaged in the light beam passing through aperture 38. In the embodiment shown a single motor drives both flags in a pair. In alternative embodiments each flag may be driven by its own dedicated motor. In other embodiments the flags in some pairs may share a motor and in other pairs, each flag has its own dedicated motor.

Motor control system (not shown) may control first motor 42 and second motor 40 independently. In one embodiment, the control of first motor 42 and second motor 40 is synchronized such that a single user control input from the user may control both motors. As the user requests increasing diffusion the motor control system will operate first motor 42 thus closing the first pair of diffusion flags 30 and 32. Once the first pair of diffusion flags 30 and 32 are partially or substantially closed then the motor control system may operate second motor 40 thus additively closing the second pair of diffusion flags 34 and 36. The resultant projected image will be diffused by the combination of both first and second diffusion flags. By using the combination of first and second diffusion flags the disclosed system provides improved range and resolution of applied diffusion.

In a further embodiment first pair of diffusion flags may have a first diffusion density and second pair of diffusion flags may have a second diffusion density that is lesser or greater than the first diffusion density. When both the first pair of diffusion flags and the second pair of diffusion flags are moved across the light beam then a combined diffusion density is provided that is greater than both the first and second diffusion densities.

In a yet further embodiment the motor control system may move first and second diffusion flags concurrently.

In another embodiment the motor control system may move the pairs independently or in the case where individual flags have dedicated motors the mothers may each be controlled individually.

In some embodiments the motors may be controlled so that the entry of the flags into the light beam is linear in nature in other embodiments the control of the motors may be non linear in nature. In yet other embodiments the rate of entry for each flag pair may be the same in other embodiments the rate of entry may be different. For example in the case where one pair of flags has a first density and the second pair has double the first pair's density and the user control signal bridges both pairs of flags, the entry function of the first pair of flags may represent at substantially twice the rate of entry of the second pair of flags and the diffusion provided by the first pair of flags may represent only approximately ⅓ of the total diffusion range provided by the two pairs of flags working in unison to a single user control signal or channel.

Motors 40 and 42 may be small low powered motors of type selected from but not limited to stepper motors, servo motors, linear actuators or low powered DC motors.

The illustrated exemplary embodiment utilizes two sets of diffusion flags, however the invention is not so limited and in further embodiments any number, two or greater, of sets of diffusion flags may be used.

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations can be made hereto without departing from the spirit and scope of the disclosure.

We claim:

1. The combination of using at least two sets of diffusion flags that may be used in [symbol]
